(19) United States
(12) Patent Application Publication
(10) Pub. No.: US 2024/0138422 A1
(43) Pub. Date: May 2, 2024

(54) SHELF-STABLE FRIED CONFECTIONERY FOOD PRODUCTS AND METHODS OF MAKING THE SAME

(71) Applicant: The Hershey Company, Hershey, PA (US)

(72) Inventors: Xiaoying Wang, Hummelstown, PA (US); Paige E. Cappello, Lancaster, PA (US); Ana C. Duque, Annville, PA (US)

(73) Assignee: The Hershey Company, Hershey, PA (US)

(21) Appl. No.: 18/547,886

(22) PCT Filed: Mar. 31, 2022
(86) PCT No.: PCT/US22/22716

§ 371 Date: Aug. 25, 2023

Related U.S. Application Data
(60) Provisional application No. 63/169,080, filed on Mar. 31, 2021.

(51) Int. Cl. A21D 10/00; A21D 8/04; A21D 13/24; A21D 13/47; A21D 13/60

(52) U.S. Cl. CPC A21D 10/007; A21D 8/042; A21D 13/24; A21D 13/47; A21D 13/60

(57) ABSTRACT

Fried confectionery food products such as doughnuts and mini doughnuts, compositions, and methods for making wherein the confectionery food products have an extended shelf-life of from more than three (3) months up to nine (9) months where water activity, moisture loss and undesirable flavor and texture changes are controlled.

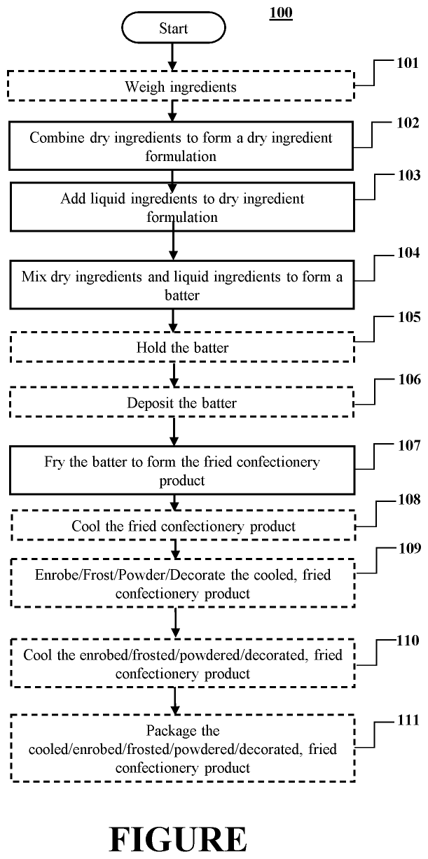

This application claims benefit of and priority to U.S. Provisional Patent Application No. 63/169,080, filed Mar. 31, 2021, the contents of which are incorporated herein by reference in its entirety.

### TECHNICAL FIELD

The present disclosure generally relates to compositions and methods for making fried confectionery food products and fried confectionery food products having an extended shelf-life.

### BACKGROUND

When stored at ambient temperatures, food products that are moist such as sweets, confectionery products, and cakes and fried doughnuts undergo a progressive deterioration known as staling. Recrystallization of the starch molecules, gluten cross-links and moisture re-distribution are the main causes of staling. Texture changes also occur due to moisture loss and recrystallization. Typical oil fried cake doughnuts have a water activity (Aw) of >0.8 and more specifically, about 0.82-0.88. Water activity above 0.75 leads to yeast and mold growth. Because of high water activity, clear plastic packaging with low moisture barrier properties is typically used. Thus, packaged fried confectionery food products such as doughnuts and mini doughnuts tend to get dry and crumbly due to moisture loss. Additionally, during frying, free fatty acids from hydrolysis of frying oil and other oil decompositions lead to oxidation during shelf-life and result in rancidity of the products. Due to these factors, packaged fried confectionery food products such as doughnuts and mini doughnuts have a shelf-life of about 3 months or less.

### SUMMARY

The present disclosure provides fried confectionery food products such as doughnuts and mini doughnuts having an extended shelf-life of from more than three (3) months up to nine (9) months where water activity, moisture loss and undesirable texture and flavor changes are controlled. Examples include a fried confectionery food product comprising a batter formed from a composition comprising a dry ingredient formulation mixed with liquid ingredients and optional food additives. The batter is fried to form the fried confectionery food product which has a water activity (Aw) of about 0.75 or less and a shelf-life greater than 3 months above frozen temperature and/or at ambient temperature.

The method for making a fried confectionery food product comprises providing and combining dry ingredients to form a dry ingredient formulation, adding liquid ingredients to the dry ingredient formulation, mixing the dry ingredients and the liquid ingredients to form a batter, and frying the batter to form the fried confectionery food product. The fried confectionery food product has a water activity of about 0.75 or less and a shelf-life of greater than 3 months above frozen temperature.

### DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

The FIGURE is a schematic representation of an exemplary method for making the fried confectionery food products of the present disclosure.

### DESCRIPTION

The present disclosure provides compositions and methods for making fried confectionery food products and fried confectionery food products, such as doughnuts having an extended shelf-life of greater than three (3) months and a water activity (Aw) of about 0.75 or less.

The product includes a batter composition and method of making to have a shelf-stable, fried confectionery food product, such as doughnuts, with an extended shelf-life from greater than three (3) months up to about nine (9) months at a temperature that is above frozen temperature and/or at ambient temperature. In some examples, the shelf-life is about four (4) months or greater, about six (6) months or greater, or about six (6) months to about nine (9) months.

The fried confectionery food product of the present disclosure has a water activity (Aw) of about 0.75 or less, about 0.72 or less, or about 0.70 or less. For purposes of this disclosure, water activity, or Aw, may be defined as the ratio of vapor pressure of a solution or mixture to that of pure water at a specific temperature. In other words, Aw equals the equilibrium relative humidity. The water activity is a measure of the free available water in the mixture. As is known in the field, water activity may be measured by measuring the equilibrium vapor pressure of a mixture at a particular temperature and expressing that value as a ratio to the equilibrium water vapor pressure as that temperature.

The fried confectionery food product is made using a specifically formulated composition of dry ingredients which are mixed with liquid ingredients, and optional food additives, to form a batter for frying to achieve an extended shelf-life of greater than 3 months and a water activity (Aw) of about 0.75 or less for the resultant fried confectionery food product. In addition to common ingredients for making a batter for a fried confectionery food product, such as flour, sugars, leavening agents, egg yolk, flavors, and fats/oil, the dry ingredient formulation contains a combination of dry ingredients used to reduce or delay starch/protein recrystallization, to hold moisture inside the doughnut, and to reduce fat/oil oxidation including enzymes, hydrocolloids, emulsifiers/surfactants, and antioxidants along with liquid ingredients of water, sugar alcohols, allulose, and humectants.

The combination and amounts of the dry ingredients including hydrocolloids, enzymes, flour, sugars, vegetable shortening, emulsifiers/surfactants, and antioxidants; along with the composition and amounts of the liquid ingredients including water, sugar alcohols, allulose, corn syrups, and humectants; and the type and amount of frying oil and the oil absorption of the fried confectionery product relative to the batter formulation, are selected to: (1) lower water activity (Aw) to 0.75 or below, (2) reduce or prevent rancidity development from oil absorbed during the frying process, and (3) reduce or prevent texture changes caused by recrystallization of polymers which are essential to achieve a fried confectionery food product, such as a doughnut, having an extended shelf-life of greater than three (3) months up to nine (9) months at a temperature above frozen temperature to ambient temperature as compared to currently available comparable fried confectionery food products, such as doughnuts, mini doughnuts, and doughnut holes which typically have a shelf-life of less than three (3) months.

More specifically, to achieve an extended shelf-life of greater than 3 months and a water activity (Aw) of about 0.75 or less for the resultant fried confectionery food product, the batter composition includes a dry ingredient formulation that contains, relative to the batter base, about 22-35% by weight of wheat flour, about 5-30% by weight of sugar, about 0.05-1.0% by weight of enzymes, about 0.05-1.0% of hydrocolloids, 0.5-10% by weight of vegetable shortening, 0.10-0.18% by weight of emulsifiers/surfactants, and about 0.05-0.2% by weight of antioxidants.

In the composition of dry ingredients for the batter for making the fried confectionery food product of the present disclosure, flour, such as cake and/or wheat flour, is employed in an amount of about 22-35% by weight. In one or more examples, the flour may be employed in an amount of about 24-32% by weight or 25-30% by weight. The amount of flour is less than in a typical cake doughnut to reduce texture changes caused by polymer recrystallization, such as starch retrogradation in flour. Cake and/or wheat flours are used in the fried confectionery food products of the present disclosure. The cake flour can be bleached and/or fortified. Other wheat flours can be used in combination with the cake flour at levels of 0-10% by weight, such as hard wheat flours, which provide a slightly different texture. Soy flour as well as milk powders, and combinations thereof can also be included in an amount of about 0-8% by weight.

Sugar is employed in the composition of dry ingredients for the batter for making the fried confectionery food product of the present disclosure in an amount of about 5-30% by weight to provide sweetness and to lower water activity (Aw). For purposes of this disclosure, “sugar” may include appropriate monosaccharides and disaccharides in either refined or unrefined forms and preferably includes both granulated and powdered sucrose, raw sugar, turbinado sugar, brown sugar, and invert sugar. In one or more examples, sugar can be employed in an amount of 10-25% by weight, or 12-22% by weight. Sugar having small particle sizes can be used for fast and complete dissolution during the process of making the fried confectionery food product to reduce water activity (Aw) more effectively. For example, sucrose having a fine particle size such as 6x, or Baker's Special sugar, and other fine granules can be used. Other sugars can also be used including, but not limited to dextrose, fructose, allulose, tagatose, trehalose, etc. Additionally, combinations of small molecule sugars and sugar alcohols can be used to lower water activity (Aw).

In addition to lowering water activity (Aw), dextrose and other sugars that are less sweet than sucrose can be used in an amount of about 0-20% by weight to balance sweetness (less sweet) with sucrose. In one or more examples, dextrose and/or other sugars that are less sweet than sucrose may be employed in an amount of about 5-15% by weight or 7-10% by weight. Other sugars that are less sweet than sucrose, include but are not limited to allulose, tagatose, trehalose, lactose, etc., and sugar alcohols, including but not limited to erythritol, maltitol, xylitol, etc., can also be used.

Enzymes are employed for shelf-life extension and to maintain a soft texture in an amount of about 0.05-1.0% by weight. In one or more examples, enzymes may be employed in an amount of about 0.05-0.5% by weight or 0.1-0.2% by weight. Suitable examples of enzymes include but are not limited to amylase such as POWERSoft®, a highly specialized amylase for sweet bakery goods, proteinease, xylanase, and combinations thereof.

Hydrocolloids are a heterogeneous group of long chain polymers (polysaccharides and proteins) characterized by their property of forming viscous dispersion and/or gels when dispersed in water and are typically used as thickening and gelling agents in foods. Hydrocolloids are employed for shelf-life extension, mouth feel, and texture by retaining moistness in the fried confectionery food products of the present disclosure in an amount of about 0.05-1.0% by weight. In one or more examples, hydrocolloids may be employed in an amount of about 0.05-0.5% by weight or 0.1-0.3% by weight. Examples of suitable hydrocolloids include, but are not limited to, sodium carboxymethylcellulose (CMC 15,000 ppa), starch and modified starch, guar gum, xanthan gum, locust bean gum, gum karaya, gum tragacanth, gum arabic and cellulose derivatives. The hydrocolloids can be used singly or in combinations thereof. Modified starches can also be used to hold moisture.

Vegetable shortening, or stable vegetable oils, are used for flavor and texture in the amount of about 0.5-10% by weight. In one or more examples, vegetable shortening may be employed in an amount of about 1.0-8.0% by weight or 2.0-5.0% by weight. “Shortening” may include any suitable edible fat or fat substitute in solid form or liquid form at ambient temperature including vegetable oil, sunflower oil, safflower oil, cottonseed oil, canola oil, soybean oil, and palm oil. In one or more examples of the present disclosure, a semisolid high oleic acid sunflower oil (having a minimum of 80% oleic acid) is employed, which contributes to achieving the desired properties.

Emulsifiers/surfactants have an effect on structure and texture of foods. They are used to help maintain freshness/softness and quality. In the present disclosure emulsifiers/surfactants are employed in an amount of about 0.10-0.18% by weight. In one or more examples, emulsifiers/surfactants may be employed in an amount of about 0.1-0.16% by weight or 0.12-0.15% by weight. Suitable emulsifiers/surfactants include but are not limited to mono and diglycerides; distilled monoglycerides; mono- and diglycerides of saturated or unsaturated fatty esters; diacetyl tartaric acid esters of mono- and diglycerides (DATEM); modified lecithin; polysorbate 20, 40, 60 or 80; sodium stearyl lactylate (SSL); propylene glycol monostearate; succinylated mono- and diglycerides; acetylated mono- and diglycerides; propylene glycol mono- and diesters of fatty acids; polyglycerol esters of fatty acids; lactylic esters of fatty acids; glyceryl monosterate; propylene glycol monopalmitate; glycerol lactopalmitate and glycerol lactostearate; and mixtures thereof. The emulsifiers may be used independently, or two or more kinds may be used in combination. In one or more examples of the present disclosure emulsifier/surfactants employed include calcium and sodium stearoyl-2-lactylates (SSL); succinylated monoglyceride (SMG); ethoxylated monoglycerides, polysorbates, and diacetyl tartaric acid esters of mono- and diglycerides (DATEM). These function by complexing with gelatinizing starch. Emulsifiers/surfactants are typically selected by the highest amylose-complexing index. Emulsifiers/surfactants with a high index are mono- and diglycerides, distilled monoglycerides, polysorbates, and SSL. By regulation in the US, 0.5% relative to the amount of flour is the maximum amount of SSL that can be employed.

Antioxidants are used in the dry ingredient formulation to preserve freshness and reduce or prevent development of rancidity during the shelf-life in an amount of about 0.05-0.2% by weight. In one or more examples, antioxidants may be employed in an amount of about 0.07-0.1% by weight. Suitable antioxidants include but are not limited to rosemary extract, tertiary butylhydroquinone (TBHQ), tocopherols, ascorbyl palmitate, and combinations thereof. If the level of the antioxidant is too high, it may not go well with doughnut flavor. For example, in the case of rosemary extract, too high of a level may lead to a rosemary flavor taste that does not go well with the doughnut flavor.

Other additional ingredients that may be included in the dry ingredient formulation include a leavening system which includes a leavening acid, e.g., sodium acid pyrophosphate (SAPP), in combination with other leavening agents such as baking soda, calcium monophosphate, and sodium aluminum phosphate. SAPP may be employed in an amount of about 0.42-1.71% by weight with a ratio of about 1:0.72 between SAPP and baking soda.

Egg yolk powder and flavorings may also be employed in the dry ingredient formulation. Egg yolk powder contributes to flavor and texture of the fried confectionery food product and can be employed in an amount of about 0.5-6% by weight, 1.0-5.0% by weight, or 2.0-4.0% by weight.

Liquid ingredients are added to the dry ingredient formulation and mixed to form a batter. The liquid ingredients include water, sugar alcohols, and humectants. Water is added to dissolve the sugar, and hydrate flour and gums in the dry ingredient formulation. To keep the water activity (Aw) low, prevent yeast and mold growth and prolong shelf-life, about 15-25% by weight of water is used in the batter formulation which is less than in typical fried cake doughnut batter formulations. In one or more examples, water may be employed in an amount of about 17-22% by weight or 18-20% by weight. Humectants act to stabilize foods through moisture control. Humectants such as glycerin, sorbitol, and allulose or other monosaccharides also may be included in the liquid formulation in an amount of about 5-15% by weight and added to the dry ingredient formulation. In one or more examples, humectants may be employed in an amount of about 7-12% by weight or 8-10% by weight. Sugar alcohols in an amount of about 0-25% by weight may also be combined with the humectants and included in the liquid formulation. Sugar alcohols reduce water activity (Aw) similar to the function of sugars. A combination of sugars and sugar alcohols helps to lower water activity (Aw) by increasing the total amount of dissolved small molecules. Other sugar alcohols can be used such as erythritol, maltitols, etc. High solubility sugar alcohols are more preferred, such as sorbitol, e.g., Sorbitol solution 70. However too high of a level of sugar alcohols will have an undesirable sensory impact such as throat burning and GI discomfort (laxation). Allulose, e.g., Allulose solution 70, is another suitable high solubility sugar that may be used. Allulose acts similar to other sugars to reduce water activity (Aw), has high solubility and is less sweet than sucrose. Allulose may be used as a solution or a dry solid form. Glycerin can also be used to reduce water activity (Aw) and reduces Aw more effectively than sugars and sugar alcohols. Other sugar or syrups, such as fructose, corn syrups, invert sugars, etc., can also be used to provide moist texture and extended shelf life of a fried confectionery product such as fried doughnuts.

Optional food additives may be included in the batter composition including but not limited to flavors, colors, preservatives, and salts, etc.

Any known mixing device can be used in the method of the present disclosure. The formulations, compositions, and batter are mixed for a sufficient period of time necessary to produce a homogenous batter composition. A suitable period of time is at least 5 minutes, more preferably at least 10 minutes, most preferably at least 15 minutes. Preferably, the compositions are mixed in at least two mixing steps, one mixing step utilizing a low mixing speed and the other a high mixing speed. High mixing speed is herein understood as a mixing speed of at least 30 Hz, more preferably at least 35 Hz, most preferably at least 40 Hz. Low mixing speed is herein understood as a mixing speed of at most 25 Hz, more preferably between 10 and 25 Hz.

The batter is fried in oil. The oil can comprise about 35-60% saturated fat and can have a melting point of about 40 to 50° C. The frying oil is selected to have lower unsaturated fat and higher saturated fat than a typical frying oil such as soybean oil. However, a high saturated fat content that is too high, i.e., above 60%, will cause a waxy mouth feeling and an unsaturated fat content that is too high, i.e., above 50% will not be stable enough. Palm shortening Advantage P-100® and palm shortening Advantage P-115® from Cargill are examples of preferred oils for frying the batter to make the fried confectionery food product of the present disclosure. Antioxidants can also be added to the frying oil to reduce or prevent development of rancidity during the shelf-life in an amount of about 0.05-0.2% by weight. In one or more examples, antioxidants may be employed in an amount of about 0.07-0.1% by weight. Suitable antioxidants include but are not limited to rosemary extract, tertiary butylhydroquinone (TBHQ), tocopherols, ascorbyl palmitate, and combinations thereof. If the level of the antioxidant is too high, it may not go well with the doughnut flavor.

The fried confectionary food product can have an oil absorption of about 15% to 30% by weight. In one or more examples, the fried confectionery food product can have an oil absorption of about 20-35% by weight or 25-30% by weight. Oil absorption is defined as(weight of fried doughnut/weight of batter−1)×100% or weight of fried doughnut−weight of batter/weight of batter×100%) . In some examples the oil absorption can be in the range of about 20-28% by weight. In one example the oil absorption can be about 25% by weight.

The fried confectionery food product may further include coatings, frosting, powders, edible decorations, or combinations thereof after cooling.

In one example, the fried confectionery food product may be a doughnut of various sizes, including typical sized doughnuts, mini doughnuts, and doughnut holes.

The present disclosure also provides a method for making a fried confectionery food product, which comprises combining dry ingredients to make a dry ingredient formulation, adding liquid ingredients to the dry ingredient formulation, mixing to form a batter, and frying the batter to form the fried confectionery food product.

Generally, the dry ingredients including the vegetable shortening are weighed and blended or mixed using any suitable blending or mixing device. The dry ingredients may be pre-blended and provided as a pre-mix. The liquid ingredients are added to the dry ingredient composition. Water may preferably be added to the dry ingredient composition first, separately from the other liquid ingredients and the other liquid ingredients subsequently added, or water may be combined with all other liquid ingredients and the resultant liquid solution added to the dry ingredients. When water is added to the dry ingredients first, separately from the other liquid ingredients, the batter is mixed for about 3 to 10 minutes at a slow speed (e.g., #1 speed on a HOBART® mixer) followed by addition of the other liquid ingredients and mixing for about 3 to 10 minutes at a higher speed (e.g., #2 speed on a HOBART® mixer). After the liquid ingredients are mixed with the dry ingredients to form the batter, the batter is allowed to sit at ambient temperature (e.g., 75° F., or 24° C.) for about 10 to 30 minutes.

After sitting and prior to frying, the batter may be portioned and formed into a pre-shaped piece and deposited into the frying oil and fried under typical frying conditions. For example, about 6 gm of the batter is portioned for mini doughnuts, or about 17 gm of batter is portioned for standard sized doughnuts and fried for example at about 375° F. (190° C.) for about 60 seconds for mini doughnuts or about 375° F. (190° C.) for about 2 minutes for standard size or larger doughnuts.

The batter is fried in oil having a melting point of about 40 to 50° C. (Mettler Dropping Point) and about 35-60% saturated fat. Tocopherol and ascorbyl palmitate may be added to the frying oil to increase oil stability. After frying, the food confectionery product may have an oil absorption of about 15-30% by weight relative to the batter as determined based on the following formula: (weight of fried doughnut/weight of batter−1)×100%. In one or more examples the oil absorption can be about 20-28% by weight, about 25% by weight, or about 15% by weight.

After removing from the frying oil, the fried confectionery food products, such as doughnuts, are allowed to cool under room temperature or forced air cooling. Coatings, toppings, frosting, powders, edible decorations, or combinations thereof can be added to the fried confectionery food product after cooling.

The fried confectionery food product may be packaged in a film having good moisture and oxygen barrier properties. Nitrogen flush (“N₂ flush”) packaging can be used to replace oxygen inside the package with nitrogen which does not react with the food products or detrimentally affect their texture and flavor like oxygen.

The resulting fried confectionery food product has an extended shelf-life extended shelf-life of greater than 3 months and a water activity (Aw) of about 0.75 or less. The fried confectionery food product, such as doughnuts, are shelf-stable, i.e., have an extended shelf-life from greater than 3 months up to about 9 months at a temperature that is above frozen temperature and typically at ambient temperature. In some examples, the shelf-life is about 4 months or greater, about 6 months or greater, or about 6 months to about 9 months. The fried confectionery food product of the present disclosure also has a low water activity (Aw) of about 0.75 or less, about 0.72 or less, about 0.70 or less as compared to a typical fried confectionery food product which has a water activity greater than 0.82.

The FIGURE is a flow diagram illustrating a method 100 of making a fried confectionery food product according to one or more examples, with reference to features described herein including but not limited to the FIGURE and associated description. As illustrated in process block 101 the method can begin by weighing the ingredients. At process block 102, the method proceeds by providing and combining the dry ingredients to form a dry ingredient formulation. The method 100 includes, at process block 103, by adding the liquid ingredients to the dry ingredient formulation, followed by mixing the dry ingredients and liquid ingredients to form a batter at process block 104. The method 100 may include, at process block 105, batter holding at ambient temperature. The method 100 can proceed at process block 106 by depositing the batter. The method 100 proceeds at block 107 by frying the batter to form the fried confectionery product. The method 100 can include further cooling at process block 108, and enrobing, frosting, powdering and/or decorating the confectionery food product at process block 109. The method 100 can additionally include a further cooling step at process block 110 and packaging at process block 111. The packaging is preferably N₂ flushed.

### EXAMPLES

The disclosure is further described in the context of the following examples, which are presented by way of illustration, but are not intended to limit the disclosure.

Table of Ingredients

| | Range |
|---|---|
| Ingredient | % w/w) |
| Dry Ingredient formulation | |
| Flour | 18-35% |
| Sugar (sucrose) | 5-30% |
| Dextrose | 0-20% |
| Enzyme | 0.05-1.0% |
| Hydrocolloid | 0.05-1.0% |
| Vegetable Shortening | 0.5-10% |
| Emulsifier/Surfactant | 0.10-0.18% |
| Antioxidant | 0.05-0.2% |
| Leavening Agent | |
| SAPP | 0.42-1.7% |
| Acidulant | 0.3-1.2% |
| Egg Yolk Powder | 0.5-6.0% |
| Flavors | |
| Liquid Ingredients | |
| Water | 15-25% |
| Sugar alcohol | 0-25% |
| Humectant | 5-15% |
| Oil Absorption | |
| (weight of fried doughnut/ | 20-35% |
| weight of batter − 1) × 100%) | |

| | Vanilla | Chocolate |
|---|---|---|
| Ingredient | Doughnut | Doughnut |
| Batter | (% w/w) | (% w/w) |
| Dry Ingredient | | |
| Formulation | | |
| Flour | | |
| Cake Flour | 26.75% | 18.70% |
| Wheat Flour | | 5% |
| Soy Flour | 5.30 | 2.5% |
| Cocoa Powder | — | 6% |
| Sugar (sucrose) | 12.04% | 21.93% |
| Dextrose | 7.0% | — |
| Enzymes | 0.15% | 0.15% |
| (POWERSoft ®) | | |
| Hydrocolloid (sodium | 0.3% | 0.2% |
| carboxymethylcellulose | | |
| (CMC 15,000 ppa) | | |
| Vegetable Shortening | 3.4% | 2.4% |
| Emulsifier/Surfactant | 0.13% | 0.12% |
| (Sodium stearoyl lactylate | | |
| (SSL)) | | |
| Antioxidant (Rosemary | 0.08% | 0.08% |
| extract) | | |
| Leavening Agent | | |
| (Sodium acid | 1.00% | 0.8% |
| pyrophosphate (SAPP)) | | |
| Acidulant (Baking | 0.72% | 0.58% |
| soda) | | |
| Egg Yolk Powder | 3.49% | 3.49% |
| Flavors | | |
| Vanilla doughnut flavor | 0.5% | |
| Vanillin | 0.04% | 0.04% |
| Chocolate flavor | | 0.5% |
| Caramel flavor | | 0.20% |
| Cocoa powder | | 6.0% |
| Liquid Ingredients | | |
| Liquid A: Water | 18.74% | 19.32% |
| Liquid B: | | |
| Sugar alcohols | | |
| Sorbitol solution 70 | 7.67% | 7.17% |
| Allulose solution 70 | 4.66% | 3.56% |
| Humectant (glycerin) | 8.03% | 7.19% |
| Total | 100.00 | 100.00 |
| Frying: | | |
| Oil Absorption | | |
| (weight of fried doughnut/ | 33.55% | 25.90% |
| weight of batter − 1) × | | |
| 100%) | | |

### Example 1

### Sensory Evaluation

A sensory evaluation was conducted with trained panelists on the Chocolate donut with peanut butter coating which has been stored at 65F/50%RH in N₂ flushed package for five months. The results showed that the chocolate donuts had better sensory liking score as compared with a commercial mini doughnut product at age of about two months. (See Table below).

| Products | Product age | Overall liking | Moistness | Soapiness |
|---|---|---|---|---|
| Chocolate doughnut | 5 months | 5.9 | 8.2 | 0 |
| Commercial mini | 2 months | 4.7 | 7.5 | 0.6 |
| doughnut | | | | |

### Sensory Panel Results

The present disclosure provides additional examples as detailed in the following clauses.

Clause 1. A fried confectionery food product comprising:

a fried batter, wherein said batter is formed from a composition comprising a dry ingredient formulation mixed with liquid ingredients and optional food additives and fried, and

wherein the fried confectionery food product has a water activity (Aw) of about 0.75 or less and a shelf-life greater than 3 months above frozen temperature.

Clause 2. The food product according to clause 1, wherein the batter is fried in oil having a melting point of about 40 to 50° C. and about 35-60% saturated fat.

Clause 3. The food product according to any one of clauses 1-2, wherein oil absorption is about 15% to 30% by weight relative to the batter.

Clause 4. The food product according to any one of clauses 1-3, wherein oil absorption is about 20-28% by weight relative to the batter.

Clause 5. The food product according to any one of clauses 1-4, wherein oil absorption is about 25% by weight relative to the batter.

Clause 6. The food product according to any one of clauses 1-5, wherein the water activity is about 0.72 or less.

Clause 7. The food product according to any one of clauses 1-5, wherein the water activity is about 0.70 or less.

Clause 8. The food product according to any one of clauses 1-7, wherein the shelf-life is about 4 months or greater above frozen temperature.

Clause 9. The food product according to any one of clauses 1-7, wherein the shelf-life is about 6 months or greater above frozen temperature.

Clause 10. The food product according to any one of clauses 1-7, wherein the shelf-life is about 6 months to about 9 months above frozen temperature.

Clause 11. The food product according to any one of clauses 1-10, wherein the dry ingredient formulation includes, on batter base, about 22-35% by weight of wheat flour, about 5-30% by weight of sugar, about 0.05-1.0% by weight of enzymes, about 0.05-1.0% of hydrocolloids, 0.5-10% by weight of vegetable shortening, 0.10-0.18% by weight of emulsifiers/surfactants, and about 0.05-0.2% by weight of antioxidants; and

the liquid ingredients include about 15-25% by weight of water, about 0-25% by weight of sugar alcohols, and about 5-15% by weight of humectants.

Clause 12. The food product according to any one of clauses 1-11, further comprising coatings, frosting, powders, edible decorations, or combinations thereof.

Clause 13. The food product according to any one of clauses 1-12, which is a doughnut, a mini doughnut or doughnut holes.

Clause 14. A method for making a fried confectionery food product, said method comprising:

combining dry ingredients to form a dry ingredient formulation;

adding liquid ingredients to the dry ingredient formulation;

mixing the dry ingredient formulation and the liquid ingredients to form a batter; and
frying the batter to form the fried confectionery food product,
wherein the fried confectionery food product has a water activity of about 0.75 or less and a shelf-life of greater than 3 months above frozen temperature.

Clause 15. The method according to clause 14, wherein frying the batter comprises frying the batter in oil having a melting point of about 40 to 50° C. and about 35-60% saturated fat.

Clause 16. The method according to any one of clauses 14-15, wherein oil absorption is about 15-30% by weight relative to the batter.

Clause 17. The method according to any one of clauses 14-15, wherein oil absorption is about 20-28% by weight relative to the batter.

Clause 18. The method according to any one of clauses 14-15, wherein oil absorption is about 25% by weight relative to the batter.

Clause 19. The method according to any one of clauses claim 14-15, wherein oil absorption is about 15% by weight relative to the batter.

Clause 20. The method according to any one of clauses 14-19, wherein the water activity is about 0.72 or less.

Clause 21. The method according to any one of clauses 14-19, wherein the water activity is about 0.70 or less.

Clause 22. The method according to any one of clauses 14-21, wherein the shelf-life is about 4 months or greater.

Clause 23. The method according to any one of clauses 14-21, wherein the shelf-life is about 6 months or greater.

Clause 24. The method according to any one of clauses 14-21, wherein the shelf-life is about 6 months to about 9 months.

Clause 25. The method according to any one of clauses 14-24, wherein the dry ingredients include about 22-35% by weight of wheat flour, about 5-30% by weight of sugar, about 0.05-1.0% by weight of enzymes, about 0.05-1.0% of hydrocolloids, 0.5-10% by weight of vegetable shortening, 0.10-0.18% by weight of emulsifiers/surfactants, and about 0.05-0.2% by weight of antioxidants; and

the liquid ingredients include about 15-25% by weight of water, about 0-25% by weight of sugar alcohols, and about 5-15% by weight of humectants.

Clause 26. The method according to clauses 14-25, further comprising, before adding the liquid ingredients, adding water to the dry ingredients.

Clause 27. The method according to any one of clauses 14-26, further comprising adding coatings, frosting, powders, edible decorations, or combinations thereof to the fried confectionery food product.

Clause 28. The method according to any one of clauses 14-26, wherein the fried confectionery food product is a doughnut, mini-doughnuts, or doughnut holes.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

While the foregoing specification illustrates and describes exemplary embodiments, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A fried confectionery food product comprising:
a fried batter, wherein said batter is formed from a composition comprising a dry ingredient formulation mixed with liquid ingredients and optional food additives and fried, and
wherein the fried confectionery food product has a water activity (Aw) of about 0.75 or less and a shelf-life greater than 3 months above frozen temperature.

2. The food product according to claim 1, wherein the batter is fried in oil having a melting point of about 40 to 50° C. and about 35-60% saturated fat.

3. The food product according to claim 2, wherein oil absorption is about 15% to 30% by weight relative to the batter.

4. The food product according to claim 1, wherein the water activity is about 0.72 or less.

5. The food product according to claim 1, wherein the water activity is about 0.70 or less.

6. The food product according to claim 1, wherein the shelf-life is about 4 months or greater above frozen temperature.

7. The food product according to claim 1, wherein the shelf-life is about 6 months or greater above frozen temperature.

8. The food product according to claim 1, wherein the dry ingredient formulation includes, on batter base, about 22-35% by weight of wheat flour, about 5-30% by weight of sugar, about 0.05-1.0% by weight of enzymes, about 0.05-1.0% of hydrocolloids, 0.5-10% by weight of vegetable shortening, 0.10-0.18% by weight of emulsifiers/surfactants, and about 0.05-0.2% by weight of antioxidants; and
the liquid ingredients include about 15-25% by weight of water, about 0-25% by weight of sugar alcohols, and about 5-15% by weight of humectants.

9. The food product according to claim 1, further comprising coatings, frosting, powders, edible decorations, or combinations thereof.

10. The food product according to claim 1, which is a doughnut, a mini doughnut or doughnut holes.

11. A method for making a fried confectionery food product, said method comprising:
combining dry ingredients to form a dry ingredient formulation;
adding liquid ingredients to the dry ingredient formulation;
mixing the dry ingredient formulation and the liquid ingredients to form a batter; and
frying the batter to form the fried confectionery food product,
wherein the fried confectionery food product has a water activity of about 0.75 or less and a shelf-life of greater than 3 months above frozen temperature.

12. The method according to claim 11, wherein frying the batter comprises frying the batter in oil having a melting point of about 40 to 50° C. and about 35-60% saturated fat.

13. The method according to claim 11, wherein oil absorption is about 15-30% by weight relative to the batter.

14. The method according to claim 11, wherein the water activity is about 0.72 or less.

15. The method according to claim 11, wherein the water activity is about 0.70 or less.

16. The method according to claim 11, wherein the shelf-life is about 4 months or greater.

17. The method according to claim 11, wherein the dry ingredients include about 22-35% by weight of wheat flour, about 5-30% by weight of sugar, about 0.05-1.0% by weight of enzymes, about 0.05-1.0% of hydrocolloids, 0.5-10% by weight of vegetable shortening, 0.10-0.18% by weight of emulsifiers/surfactants, and about 0.05-0.2% by weight of antioxidants; and
the liquid ingredients include about 15-25% by weight of water, about 0-25% by weight of sugar alcohols, and about 5-15% by weight of humectants.

18. The method according to claim 11, further comprising, before adding the liquid ingredients, adding water to the dry ingredients.

19. The method according to claim 11, further comprising adding coatings, frosting, powders, edible decorations, or combinations thereof to the fried confectionery food product.

20. The method according to claim 11, wherein the fried confectionery food product is a doughnut, mini-doughnuts, or doughnut holes.
